(19) United States
(12) Patent Application Publication
(10) Pub. No.: US 2002/0023165 A1
(43) Pub. Date: Feb. 21, 2002

(54) Method and apparatus for encoder-based distribution of live video and other streaming content

(76) Inventor: Nils B. Lahr, Antioch Heights, CA (US)

Correspondence Address: Stacey J. Longanecker, Roylance, Abrams, Berdo & Goodman, Suite 600, 1300 19th Street, N.W., Washington, DC, 20036, US

(21) Appl. No.: 09/770,633

(22) Filed: Jan. 29, 2001

Related U.S. Application Data
(60) Provisional application No. 60/178,749, filed on Jan. 28, 2000.

(51) Int. Cl. H04N 7/173; G06F 15/16

(52) U.S. Cl. 709/231; 725/105

(57) ABSTRACT

An encoding scheme converts the output of an encoder to broadcast IP stream that is translated by remote receivers or user devices to the original encoder output protocol. A protocol translation allows the encoder to be distributed to provide for larger scaling of encoders and servers, and better quality of service (QOS) and control over the distribution of streaming media. A server can also be provided with a built-in encoding scheme that provides a broadcast IP stream.

This application claims the benefit of U.S. provisional application Ser. No. 60/178,749, filed Jan. 28, 2000.

### CROSS REFERENCE TO RELATED APPLICATIONS

Related subject matter is disclosed in co-pending U.S. patent application of Nils B. Lahr et al., filed Sep. 28, 1998, entitled “Streaming Media Transparency” (attorney's file IBC-P001); in co-pending U.S. patent application of Nils B. Lahr, filed even date herewith, entitled “Method and Apparatus for Client-Side Authentication and Stream Selection in a Content Distribution System” (attorney's file 39505A); in co-pending U.S. patent application of Nils B. Lahr, filed even date herewith, entitled “A System and Method for Rewriting A Media Resource Request and/or Response Between Origin Server and Client” (attorney's file 39511A); in co-pending U.S. patent application of Nils B. Lahr, filed even date herewith, entitled “Method And System For Real-Time Distributed Data Mining And Analysis For Networks” (attorney's file 39510A); in co-pending U.S. patent application of Nils B. Lahr, filed even date herewith, entitled “Method and Apparatus for Using Single Uniform Resource Locator for Resources With Multiple Formats” (attorney's file 39502A); in co-pending U.S. patent application of Nils B. Lahr et al., filed even date herewith, entitled “A System and Method for Mirroring and Caching Compressed Data in a Content Distribution System” (attorney's file 39565A); in co-pending U.S. patent application of Nils B. Lahr, filed even date herewith, entitled “A System and Method for Determining Optimal Server in a Distributed Network for Serving Content Streams” (attorney's file 39551A); and in co-pending U.S. patent application of Nils B. Lahr, filed even date herewith, entitled “A System and Method for Performing Broadcast-Enabled Disk Drive Replication in a Distributed Data Delivery Network” (attorney's file 39564A); the entire contents of each of these applications being expressly incorporated herein by reference.

### FIELD OF THE INVENTION

The invention relates to a method and apparatus for providing multicast output from an encoder to one or more servers or other receive sites.

### BACKGROUND OF THE INVENTION

Demand for streaming audio and video content on Internet and intranet sites is increasing to present, for example, news and entertainment content to users (e.g., pay-per-view programming and digital rights management), as well as provide advertising and commerce services, distance learning and the like. Before the development of streaming technology, audio and video content was downloaded from the Web, for example, using download-and-play technology. This download-and-play technology was extremely slow, even with the downloading of relatively small media files, since a media file had to be first downloaded in its entirety before it could be played. Streaming technology allows for the distribution and playback of much larger media files in a more efficient manner.

Streaming of media content can be accomplished using a web server or a streaming media server. A web server allows media files to be accessed via Web pages having the media files' uniform resource locators (URLs). Web server streaming generally uses Hyper Text Transport Protocol (HTTP) for communication between the server and the user or client. HTTP operates on top of transmission control protocol (TCP), which handles data transfers. TCP is designed to maximize data transfer rate, while ensuring overall stability and high throughput in a network, and employs packet loss reporting and re-transmission of lost packets. For example, TCP allows for the variability of the data rate, depending on the packet loss rate.

While a streaming media server can use HTTP/TCP, they also use such protocols as user datagram protocol (UDP) to improve the streaming experience. UDP reduces the bandwidth needed due to it being only a unidirectional protocol. Unlike TCP, UDP does not use ACK's and NAC's. Unlike TCP, UDP and similar protocols are faster protocols without retransmission or data-rate management functionality. UDP and similar protocols are therefore advantageous for transmitting real-time audio and video data, which can tolerate some lost packets. These protocols allow higher bandwidth to be delivered to the client than TCP since bandwidth is not used to re-transmit lost packets or keep track of packet order. UDP traffic also receives higher priority than TCP traffic on the Internet.

Multicast delivery of content is becoming more prevalent. Multicast networking technology allows a single stream to be distributed to multiple points in a network, while also reducing bandwidth use. A number of servers, however, do not support redistribution of a multicast stream either via multicast or unicast to a client. Servers that use TCP or other connection-oriented protocols require set-up and tear-down of virtual connections with users and therefore a considerable amount of handshaking to establish a virtual connection, which is not desirable in applications such as streaming and multicasting of content. Thus, a need exists for an encoding process to convert streams that are typically full-duplex (e.g., TCP streams) into a multicast stream for distribution. Further, there is a need to make existing video servers accept this multicast stream and redistribute it to clients in much the same way that they currently redistribute a stream provided to it via a TCP based-connection. The TCP-based connections that are currently supported, however, are not scalable to a large network of edge stream servers.

### SUMMARY OF THE INVENTION

The above described disadvantages are overcome and a number of advantages are realized by a method and apparatus for protocol translation whereby the output of an encoder (e.g., a digital video encoder) can be broadcast using conventional broadcast IP technology. A remote receiver/protocol converter receives the broadcast IP stream and spoofs the original protocol employed by the encoder. This apparatus or method can either exist as a separate application or can be built directly into the encoder or server.

In accordance with an aspect of the present invention, a server is provided with a built-in encoding function that provides a broadcast IP stream. The broadcast IP stream employs header information that can be updated within a broadcast stream to facilitate reception and parsing of a received broadcast stream into a real-time stream.

### BRIEF DESCRIPTION OF DRAWINGS

The various aspects, advantages and novel features of the present invention will be more readily comprehended from the following detailed description when read in conjunction with the appended drawings, in which:

FIGS. 1, 2 and 3 are block diagrams of conventional content distribution systems;

FIG. 4 illustrates an Internet broadcast system for streaming media constructed in accordance with an embodiment of the present invention;

FIG. 5 is a block diagram of a media serving system constructed in accordance with an embodiment of the present invention;

FIG. 6 is a block diagram of a data center constructed in accordance with an embodiment of the present invention;

FIG. 7 illustrates data flow in a Internet broadcast system for streaming media constructed in accordance with an embodiment of the present invention;

FIGS. 8, 9 and 10 illustrate acquisition, broadcasting and reception phases employed in a Internet broadcast system for streaming media constructed in accordance with an embodiment of the present invention;

FIG. 11 illustrates transport data management in a Internet broadcast system for streaming media constructed in accordance with an embodiment of the present invention;

FIG. 12 is a block diagram of a content distribution system constructed in accordance with an embodiment of the present invention; and

FIG. 13 is a block diagram of a content distribution system constructed in accordance with an embodiment of the present invention.

Throughout the drawing figures, like reference numerals will be understood to refer to like parts and components.

### DETAILED DESCRIPTION OF THE PREFERRED EMBODIMENTS

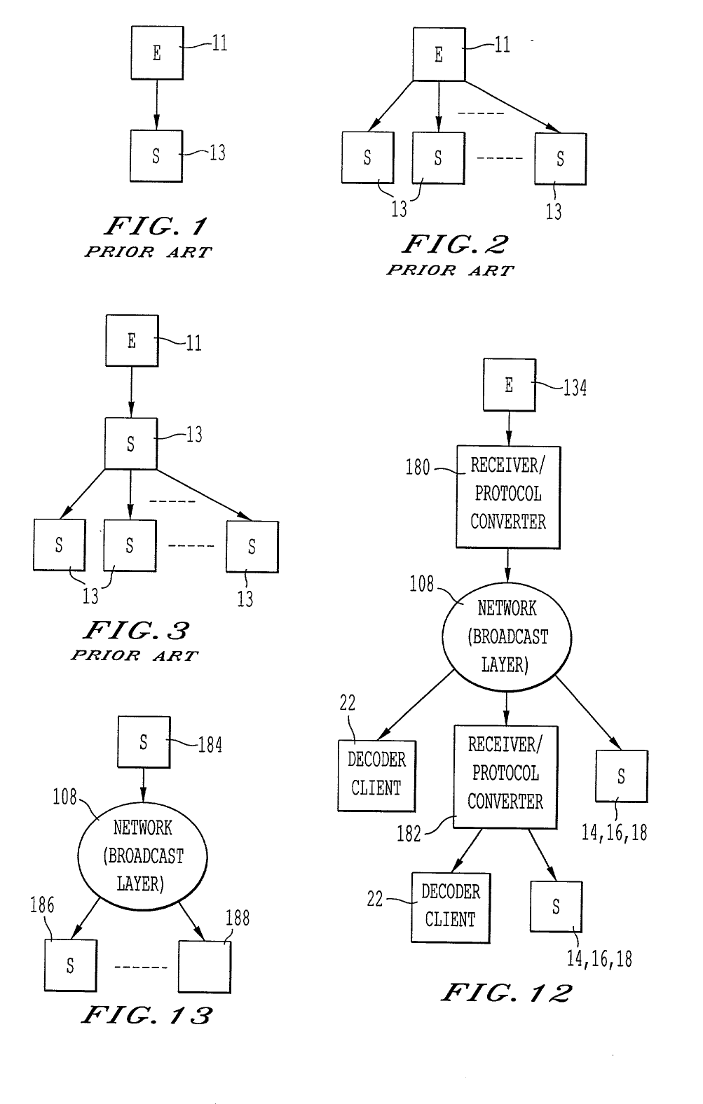

Existing encoders support a protocol that is intended for a particular proprietary server. Thus, other protocols are needed to distribute a stream from one server to another. With reference to FIGS. 1, 2 and 3, existing encoders 10 are limited to connection with a local server or servers 12, and are therefore unable to broadcast their output to multiple reception points. Separate encoded streams are unicast to respective servers, which is in contrast with generating a single encoded stream that is multicast to different servers. With reference to FIG. 3, conventional local servers also cannot output the encoder signals in a format for transmission to multiple servers at the same time. In other words, a conventional server is limited to providing unicast streams to respective servers, as opposed to generating a multicast stream.

One of the reasons for these shortcomings of conventional servers is the use of connection-oriented protocols such as TCP. As stated previously, IP-based media servers are available which provide broadcast output. These servers, however, cannot be monitored and the broadcast output is different from the encoder output. Thus, scalability is limited. Further, IP-based media servers are not configured to process a broadcast stream in order to re-broadcast the stream to other clients or servers.

In accordance with the present invention, the output of an encoder is converted to, or simply output as, a broadcast IP stream, which can be translated by remote receivers or user devices to the original encoder output protocol or, if the original output is multicast, accepted ‘as is’. The protocol translation of the present invention essentially allows an encoder to be distributed (e.g., to appear at plural remote locations simultaneously) and therefore provides for larger scaling of encoders and servers, as well as better quality of service (QOS) and control over the distribution of streams. In accordance with another aspect of the present invention, an encoding scheme is provided in a server to enable it to output a broadcast IP stream.

The encoding of the present invention is described herein for illustrative purposes in connection with an exemplary Internet broadcast system 10 for streaming media. It is to be understood that implementation of the invention is not limited to the architecture of the system 10 described herein.

1. System Component Overview

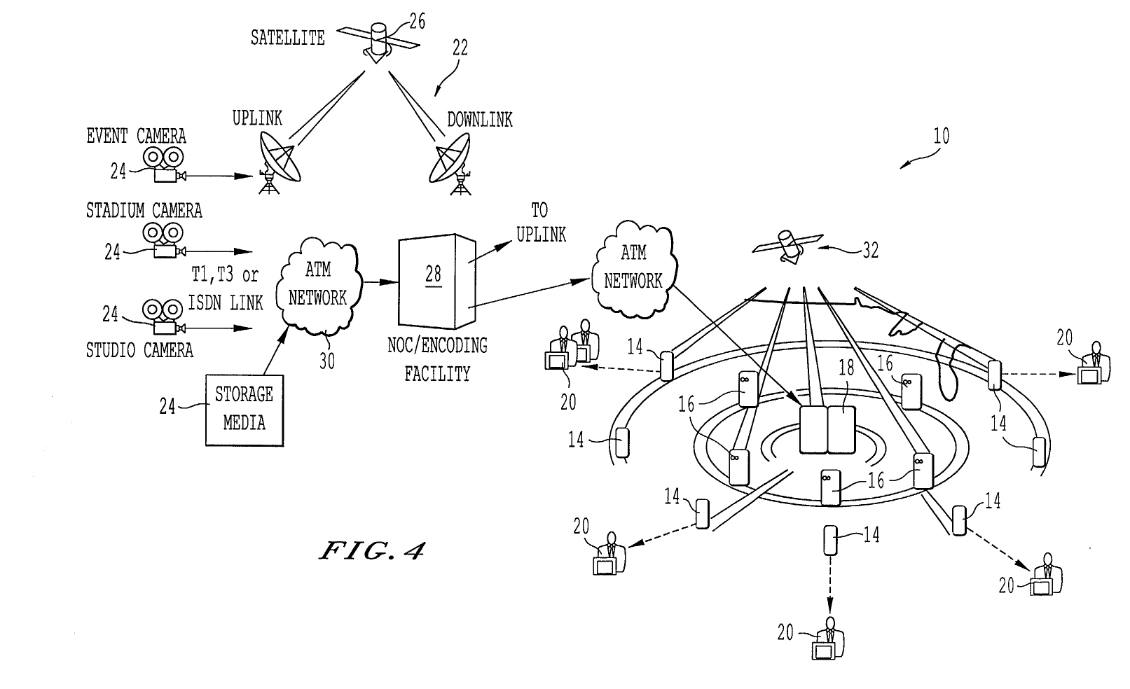

With reference to FIG. 4, a system 10 is provided which captures media (e.g., using a private network), and broadcasts the media (e.g., by satellite) to servers located at the edge of the Internet, that is, where users 20 connect to the Internet such as at a local Internet service provider or ISP. The system 10 bypasses the congestion and expense associated with the Internet backbone to deliver high-fidelity streams at low cost to servers located as close to end users 20 as possible.

To maximize performance, scalability and availability, the system 10 deploys the servers in a tiered hierarchy distribution network indicated generally at 12 that can be built from different numbers and combinations of network building components comprising media serving systems 14, regional data centers 16 and master data centers 18. The system also comprises an acquisition network 22 that is preferably a dedicated network for obtaining media or content for distribution from different sources. The acquisition network 22 can operate as a network operations center (NOC) which manages the content to be distributed, as well as the resources for distributing it. For example, content is preferably dynamically distributed across the system network 12 in response to changing traffic patterns in accordance with the present invention. While only one master data center 18 is illustrated, it is to be understood that the system can employ multiple master data centers, or none at all and simply use regional data centers 16 and media serving systems 14, or only media serving systems 14.

An illustrative acquisition network 22 comprises content sources 24 such as content received from audio and/or video equipment employed at a stadium for a live broadcast via satellite 26. The broadcast signal is provided to an encoding facility 28. Live or simulated live broadcasts can also be rendered via stadium or studio cameras, for example, and transmitted via a terrestrial network such as a T1, T3 or ISDN or other type of a dedicated network 30 that employs asynchronous transfer mode (ATM) or other technology. In addition to live analog or digital signals, the content can include analog tape recordings, and digitally stored information (e.g., media-on-demand or MOD), among other types of content. Further, in addition to a dedicated link 30 or a satellite link 26, the content harvested by the acquisition network 22 can be received via the Internet, other wireless communication links besides a satellite link, or even via shipment of storage media containing the content, among other methods. The encoding facility 28 converts raw content such as digital video into Internet-ready data in different formats such as the Microsoft Windows Media (MWM), RealNetworks G2, or Apple QuickTime (QT) formats. The system 10 also employs unique encoding methods to maximize fidelity of the audio and video signals that are delivered via multicast by the distribution network 12.

With continued reference to FIG. 4, the encoding facility 28 provides encoded data to the hierarchical distribution network 12 via a broadcast backbone which is preferably a point-to-multipoint distribution network. While a satellite link indicated generally at 32 is used, the broadcast backbone employed by the system 10 of the present invention is preferably a hybrid fiber-satellite transmission system that also comprises a terrestrial network 33. The satellite link 32 is preferably dedicated and independent of a satellite link 26 employed for acquisition purposes. The tiered network building components 14, 16 and 18 are each equipped with satellite transceivers to allow the system 10 to simultaneously deliver live streams to all server tiers 14, 16 and 18 and rapidly update on-demand content stored at any tier. When a satellite link 32 is unavailable or impractical, however, the system 10 broadcasts live and on-demand content though fiber links provided in the hierarchical distribution network 12. Where the feed is pulled from in case of a failure is based on a set of routing rules that include priorities, weighting, and so on. In other words, the feed is pulled in a manner similar to the way routers currently operate, but at the actual stream level.

The system 10 employs a director agent to monitor the status of all of the tiers of the distribution network 12 and redirect users 20 to the optimal server, depending on the requested content. The director agent can originate, for example, from the NOC/encoding facility 28. The system employs an Internet Protocol or IP address map to determine where a user 20 is located and then identifies which of the tiered servers 14, 16 and 18 can deliver the highest quality stream, depending on network performance, content location, central processing unit load for each network component, application status, among other factors. Cookies and data from other databases can also be employed to facilitate this system intelligence.

Media serving systems 14 comprise hardware and software installed in ISP facilities at the edge of the Internet. The media serving systems preferably only serve users 20 in its subnetwork. Thus, the media serving systems 14 are configured to provide the best media transmission quality possible because the end users 20 are local. A media serving system 14 is similar to an ISP caching server, except that the content served from the media serving system is controlled by the content provider that input the content into the system 10. The media serving systems 14 each serve live streams delivered by the satellite link 32, and store popular content such as current and/or geographically-specific news clips. Each media serving system 14 manages its storage space and deletes content that is less frequently accessed by users 20 in its subnetwork. Content that is not stored at the media serving system 14 can be served from regional data centers.

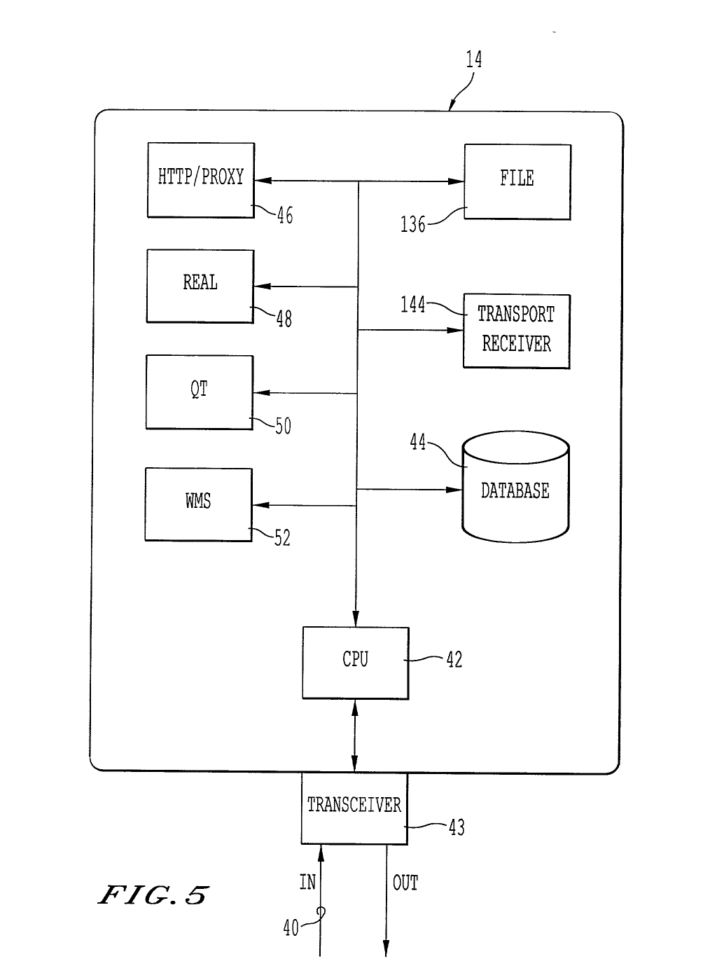

With reference to FIG. 5, a media serving system 14 comprises an input 40 from a satellite and/or terrestrial signal transceiver 43. The media serving system 14 can output content to users 20 in its subnetwork or control/feedback signals for transmission to the NOC or another hierarchical component in the system 10 via a wireline or wireless communication network. The media serving system 14 has a central processing unit 42 and a local storage device 44. A file transport module 136 and a transport receiver 144, which are described below with reference to FIG. 10, are provided to facilitate reception of content from the broadcast backbone. The media serving system 14 also preferably comprises one or more of an HTTP/Proxy server 46, a Real server 48, a QT server 50 and a WMS server 52 to provide content to users 20 in a selected format. The media serving system can also support Windows and Real caching servers, allowing direct connections to a local box regardless of whether the content is available. The content in the network 12 is then located and cached locally for playback. This allows for split live feeds by a local media serving system 14 regardless of whether is being sent via a broadcast or feed mechanism. Thus, pull splits from a media serving system 14 are supported, as well as broadcast streams that are essentially push splits with forward caching. Also, the database 44 and file system 136 can be local or remote, depending on where the media serving system 14 is installed.

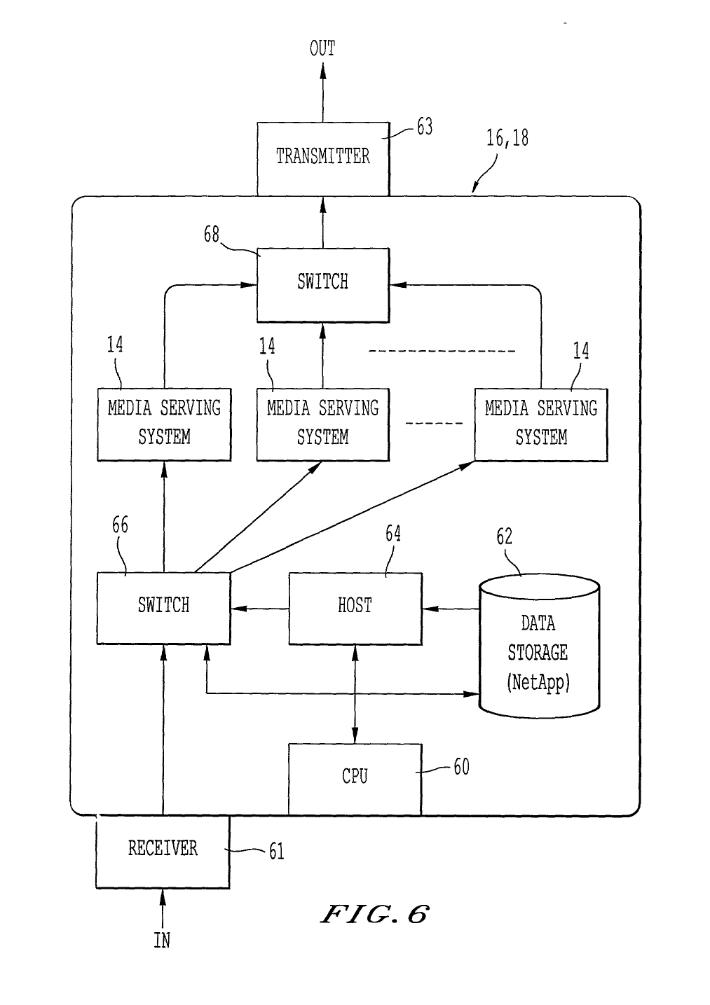

The regional data centers 16 are located at strategic points around the Internet backbone. With reference to FIG. 6, a regional data center 16 comprises a satellite and/or terrestrial signal transceiver, indicated at 61 and 63, to receive inputs and to output content to users 20 or control/feedback signals for transmission to the NOC or another hierarchical component in the system 10 via wireline or wireless communication network. A regional data center 16 preferably has more hardware than a media serving system 14 such as gigabit routers and load-balancing switches 66 and 68, along with high-capacity servers (e.g., plural media serving systems 14) and a storage device 62. The CPU 60 and host 64 are operable to facilitate storage and delivery of less frequently accessed on-demand content using the servers 14 and switches 66 and 68. The regional data centers 16 also deliver content if a standalone media serving system 14 is not available to a particular user 20. The director agent software preferably continuously monitors the status of the standalone media serving systems 14 and reroutes users 20 to the nearest regional data center 16 if the nearest media serving system 14 fails, reaches its fulfillment capacity or drops packets. Users 20 are typically assigned to the regional data center 14 that corresponds with the Internet backbone provider that serves their ISP, thereby maximizing performance of the second tier of the distribution network 12. The regional data centers 14 also serve any users 20 whose ISP does not have an edge server.

The master data centers 18 are similar to regional data centers 16, except that they are preferably much larger hardware deployments and are preferably located in a few peered data centers and co-location facilities, which provide the master data centers with connections to thousands of ISPs. With reference to FIG. 6, master data centers 18 comprises multiterabyte storage systems (e.g., a larger number of media serving systems 14) to manage large libraries of content created, for example, by major media companies. The director agent automatically routes traffic to the closest master data center 18 if a media serving system 14 or regional data center 16 is unavailable. The master data centers 18 can therefore absorb massive surges in demand without impacting the basic operation and reliability of the network.

Transmissions can occur out of the data centers 16 and 18. In the case of the satellite 32, however, transmissions can also be implemented by taking what is being received and routing a copy thereof directly to the uplink system without first passing through the media serving systems 14.

2. System Operation Overview

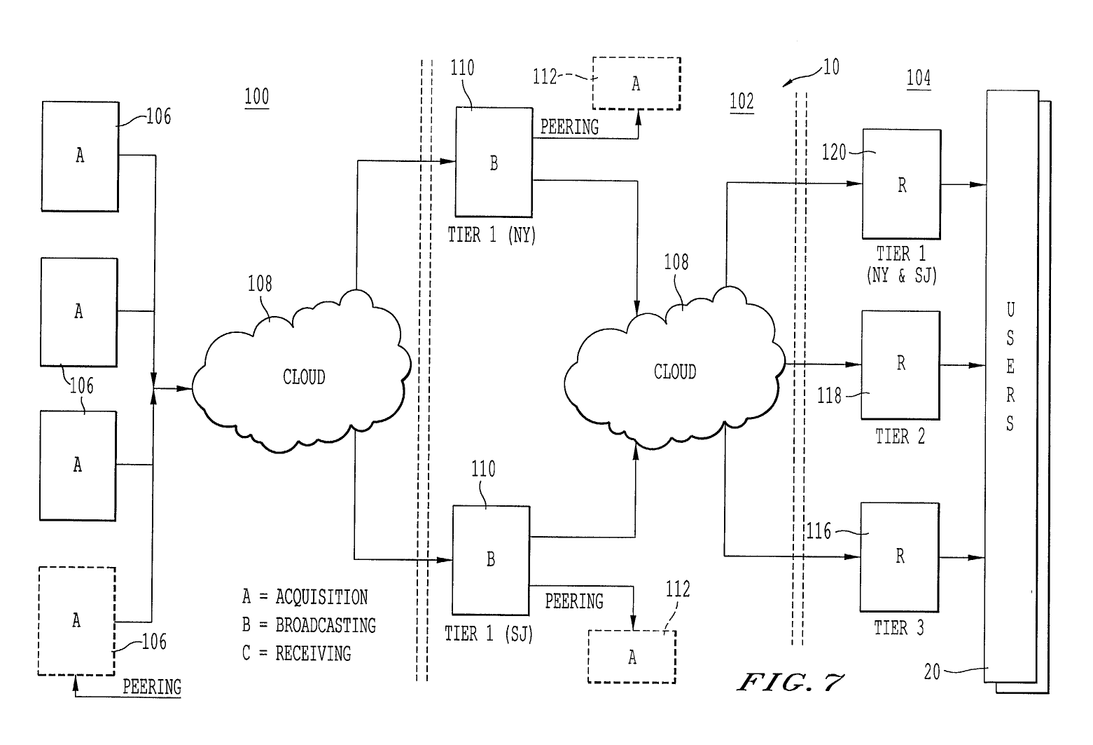

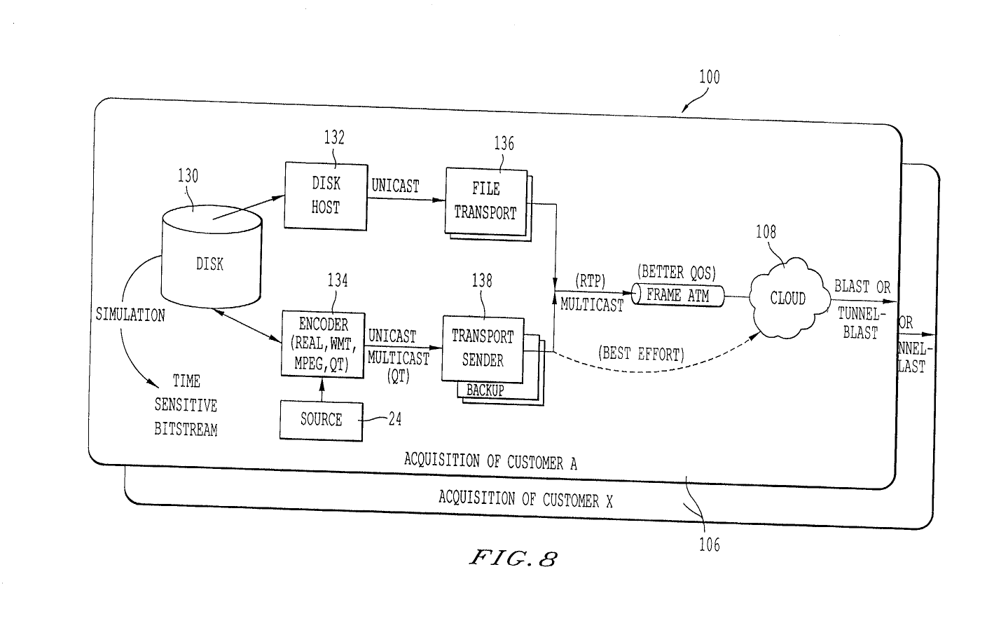

With reference to FIG. 7, the Internet broadcast system 10 for streaming media generally comprises three phases, that is, acquisition 100, broadcasting 102 and receiving 104. In the acquisition phase 100, content is provided to the system 10 from different sources such as Internet content providers (ICPs) or event or studio content sources. As stated previously, content can be received from audio and/or video equipment employed at a stadium for a live broadcast. The content can be, for example, live analog signals, live digital signals, analog tape recordings, digitally stored information (e.g., media-on-demand or MOD), among other types of content. The content can be locally encoded or transcoded at the source using, for example, file transport protocol (FTP), MSBD, or real-time transport protocol/real-time streaming protocol (RTP/RTSP). The content is collected using one or more acquisition modules 106, which are described in more detail below in connection with FIG. 8. The acquisition modules 106 represent different feeds to the system 10 in the acquisition network 12 and can be co-located or distributed. Generally, acquisition modules 106 can perform remote transcoding or encoding of content using FTP, MSBD, or RTP/RTSP or other protocols prior to transmission to a broadcaster 110 for multicast to edge devices and subsequent rendering to users 20 located relatively near to one of the edge devices. The content is then converted into a broadcast packet in accordance with an aspect of the present invention. This process of packaging packets in a manner to facilitate multicasting, and to provide insight at reception sites as to what the packets are and what media they represent, constitutes a significant advantage of the system 10 over other content delivery systems.

Content obtained via the acquisition phase 100 is preferably provided to one or more broadcasters 110 via a multicast cloud or network(s) 108. The content is unicast or preferably multicast from the different acquisition modules 106 to the broadcasters 110 via the cloud 108. As stated above, the cloud 108 is preferably a point-to-multipoint broadcast backbone. The cloud 108 can be implemented as one or more of a wireless network such as a satellite network or a terrestrial or wireline network such as optical fiber link. The cloud 108 can employ a dedicated ATM link or the Internet backbone, as well as a satellite link, to multicast streaming media. The broadcasters 110 are preferably in tier 120, that is, they are master data centers 18 that receive content from the acquisition modules 106 and, in turn, broadcast the content to other receivers in tiers 116, 118 and 120.

During the broadcasting phase 102, broadcasters 110 operate as gatekeepers, as described below in connection with FIG. 9, to transmit content to a number of receivers in the tiers 116, 118 and 120 via paths in the multicast cloud 108. The broadcasters 110 support peering with other acquisition modules indicated generally at 112. The peering relationship between a broadcaster 110 and an acquisition module 112 is via a direct link and each device agrees to forward the packets of the other device and to otherwise share content directly across this link, as opposed to a standard Internet backbone.

During the reception phase 104, high-fidelity streams that have been transmitted via the broadcasters 110 across the multicast cloud 108 are received by servers 14, 16 and 18 located as close to end users as possible. The system 10 is therefore advantageous in that streams bypass congestion and expense associated with the Internet backbone. As stated previously, the servers are preferably deployed in a tiered hierarchy comprising media serving systems 14, regional data centers 16 and master data centers 18 that correspond to tiers 116, 118 and 120, respectively. The tiers 116, 118 and 120 provide serving functions (e.g., transcoding from RTP to MMS, RealNet, HTTP, WAP or other protocol), as well as delivery via a local area network (LAN), the Internet, a wireless network or other network to user devices 122 for rendering (e.g., PCs, workstations, set-top boxes such as for cable, WebTV, DTV, and so on, telephony devices, and the like). The tiers in the reception phase are described in further detail below in connection with FIG. 10.

3. Data Transport Management

With reference to FIGS. 8, 9 and 10, hardware and/or software components associated with the acquisition 100, broadcasting 102 and reception phases 104 will now be described. These hardware and/or software components comprise various transport components for supporting MOD or live stream content distribution in one or more multicast-enabled networks in the system 10. The transport components can be, but are not limited to, a file transport module, a transport sender, a transport broadcaster, and a transport receiver. The content is preferably characterized as either live content and simulated/scheduled live content, or MOD (i.e., essentially any file). Streaming media such as live content or simulated/scheduled live content are managed and transported similarly, while MOD is handled differently.

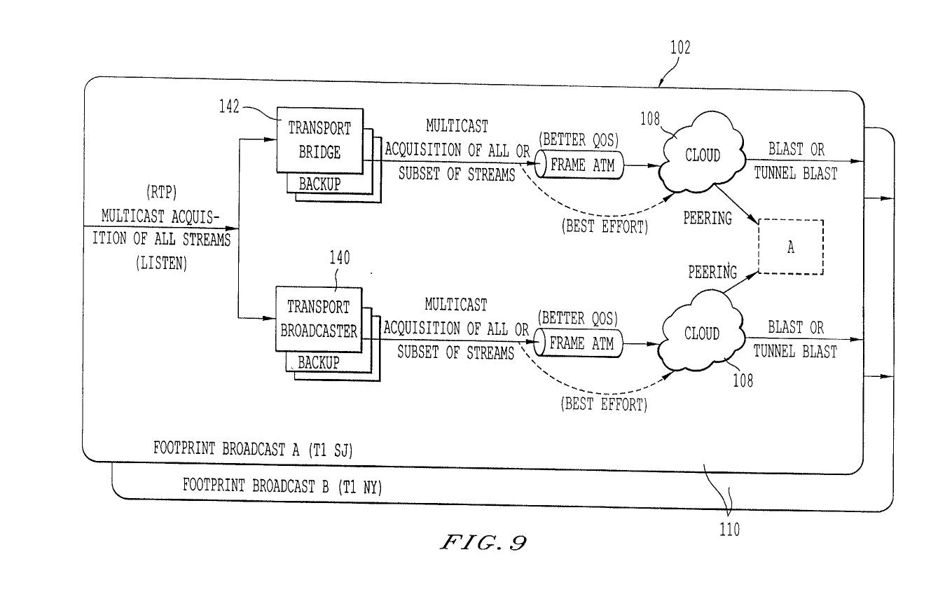

Acquisition for plural customers A through X is illustrated in FIG. 8. By way of an example, acquisition for customer A involves an encoder, as indicated at 134, which can employ Real, WMT, MPEG, QT, among other encoding schemes with content from a source 24. The encoder also encodes packets into a format to facilitate broadcasting in accordance with the present invention. A disk 130 stores content from different sources and provides MOD streams, for example, to a disk host 132. The disk host 132 can be proxying the content or hosting it. Live content, teleconferencing, stock and weather data generating systems, and the like, on the other hand, is also encoded. The disk host 132 unicasts the MOD streams to a file transport module 136, whereas the encoder 134 provides the live streams to a transport sender 138 via unicast or multicast. The encoder can employ either unicast or multicast if QT is used. Conversion from unicast to multicast is not always needed, but multicast-to-multicast conversion can be useful. The file transport module 136 transfers MOD content to a multicast-enabled network. The transport sender 138 pulls stream data from a media encoder 134 or an optional aggregator and sends stream announcements (e.g., using session announcement protocol and session description protocol (SAP/SDP)) and stream data to multicast Internet protocol (IP) addresses and ports received from a transport manager. The transport manager is described below with reference to FIG. 11. When a Real G2 server is used to push a stream, as opposed to a pulling scheme, an aggregator can be used to convert from a push scheme to a pull scheme. The components described in connection with FIG. 8 can be deployed at the encoding center 28 or in a distributed manner at, for example, content provider facilities.

FIG. 9 illustrates an exemplary footprint for one of a plurality of broadcasts. As shown in FIG. 9, the broadcasting phase 102 is implemented using a transport broadcaster 140 and a transport bridge 142. These two modules are preferably implemented as one software program, but different functions, at a master data center 18 or network operations center. The transport broadcaster 140 performs transport path management, whereas the transport bridge 142 provides for peering. The broadcaster 140 and bridge 142 get data from the multicast cloud (e.g., network 108) being guided by the transport manager and forward it to an appropriate transport path. One transport broadcaster 140, for example, can be used to represent one transport path such as satellite uplink or fiber between data centers or even a cross-continental link to a data center in Asia from a data center in North America. The broadcaster 140 and bridge 142 listen to stream announcements from transport senders 138 and enable and disable multicast traffic to another transport path, accordingly. They can also tunnel multicast traffic by using TCP to send stream information and data to another multicast-enabled network. Thus, broadcasters 110 transmit corresponding subsets of the acquisition phase streams that are sent via the multicast cloud 108. In other words, the broadcasters 110 operate as gatekeepers for their respective transport paths, that is, they pass any streams that need to be sent via their corresponding path and prevent passage of other streams. Transmission can also be accomplished using TCP to another receiver regardless whether the system that the receiver is in is muiticast-enabled. Thus, multicast operation can be disabled and the broadcast is still routed and distributed, although not quite as effectively or inexpensively as multicast.

FIG. 10 illustrates the reception phase 104 at one of a plurality of servers or data centers. As stated above, the data centers are preferably deployed in a tiered hierarchy 116, 118 and 120 comprising media serving systems 14, regional data centers 16 and master data centers 18, respectively. The tiers 116, 118 and 120 each comprise a transport receiver 144. Transport receivers can be grouped using, for example, the transport manager. Each transport receiver 144 receives those streams from the broadcasters 110 that are being sent to a group to which the receiver belongs. The transport receiver listens to stream announcements, receives stream data from plural transport senders 138 and feeds the stream data to media servers 146. The transport receiver 144 can also switch streams, as indicated at 154 (e.g., to replace a live stream with a local MOD feed for advertisement insertion purposes). The stream switch 154 can be a plug-in in the Media Server 14 or exist in the server itself to enable switching per end-user 20. The plug-in can interact with an advertisement platform to inject advertisements into streams. The MOD streams are received via the file transport 136 and stored, as indicated via the disk host 148, database 150 and proxy cache/HTTP server 152. The servers 146 and 152 provide content streams to users 20.

4. Encoding

The transport components described in connection with FIGS. 8, 9 and 10 are advantageous in that they generalize data input schemes from encoders and optional aggregators to data senders, data packets within the system 10, and data feeding from data receivers to media servers, to support essentially any media format. The transport components preferably employ RTP as a packet format and XML-based remote procedure calls (XBM) to communicate between transport components.

The transport manager will now be described with reference to FIG. 11 which illustrates an overview of transport data management. The transport manager is preferably a software module deployed at the encoding facility 28 or other facility designated as a NOC. As shown in FIG. 11, multiple data sources 14 (e.g., database content, programs and applications) provide content as input into the transport manager 170. Information regarding the content from these data sources is also provided to the transport manager such as identification of input source 14 and output destination (e.g., groups of receivers). Decisions as to where content streams are to be sent and which groups of servers are to receive the streams can be predefined and indicated to the transport manager 170 as a configuration file or XBM function call in real-time. This information can also be entered via a graphical user interface (GUI) 172 or command line utility. In any event, the information is stored in a local database 174. The database 174 also stores information for respective streams relating to defined maximum and minimum IP address and port ranges, bandwidth usage, groups or communities intended to receive the streams, network and stream names, as well as information for user authentication to protect against unauthorized use of streams or other distributed data.

With continued reference to FIG. 11, a customer requests to stream content via the system 10 using, for example, the GUI 172. The request can include the customer's name and account information, the stream name to be published (i.e., distributed) and the IP address and port of the encoder or media server from which the stream can be pulled. Requests and responses are sent via the multicast network (e.g., cloud 108) using separate multicast addresses for each kind of transport component (e.g., a transport sender channel, a broadcaster channel, a transport manager channel and a transport receiver channel), or one multicast address and different ports. IP and port combinations can be used for TCP transmissions. An operator at the NOC 28 can approve the request if sufficient system resources are available such as bandwidth or media server capacity. Automatic approval can be provided by a scheduling system configured to provide immediate responses to attempted broadcasts. The transport manager 170 preferably pulls stream requests periodically. In response to an approved request, the transport manager 170 generates a transport command in response to the request (e.g., an XML-based remote procedure call (XBM)) to the transport sender 138 corresponding to that customer which provides the assigned multicast IP address and port that the transport sender is allowed to use in the system 10.

The transport sender 138 receives the XBM call and responds by announcing the stream that is going to be sent. All of the transport components listen to the announcement. Once the transport sender 138 commences sending the stream into the assigned multicast IP address and port, the corresponding transport broadcaster 140 filter the stream. The transport receiver 144 joins the multicast IP address and receives the data or stream if the stream is intended for a group to which the receiver 144 belongs. As stated above in connection with FIG. 7, the receiver converts the steam received via the cloud 108 and sends it to the media server available to the users 20. The data is then provided to the media server associated with the receiver. Receivers 144 and broadcasters 140 track announcements that they have honored using link lists.

As stated above, the transport components described with reference to FIGS. 7-11 preferably use RPT as a data transport protocol. Accordingly, Windows Media, RealG2 and QT packets are wrapped into RTP packets. The acquisition network 22 preferably employs an RTP stack to facilitate processing any data packets, wrapping the data packets with RTP header and sending the data packets. RTSP connection information is generally all that is needed to commence streaming.

RTP is used for transmitting real-time data such as audio and video, and particularly for time-sensitive data such as streaming media, whether transmission is unicast or multicast. RTP employs User Datagram Protocol (UDP), as opposed to Transmission Control Protocol (TCP) that is typically used for non-real-time data such as file transfer and e-mail. Unlike with TCP, software and hardware devices that create and carry UDP packets do not fragment and reassemble them before they have reached their intended destination, which is important in streaming applications. RTP adds header information that is separate from the payload (e.g., content to be distributed) that can be used by the receiver. The header information is merely interpreted as payload by routers that are not configured to use it.

RTSP is an application-level protocol for control over the delivery of data with real-time properties and provides an extensible framework to enable controlled, on-demand delivery of real-time data including live feeds and stored clips. RTSP can control multiple data delivery sessions, provide means for choosing delivery channels such as UDP, multicast UDP and TCP, and provide means for choosing delivery mechanisms based on RTP. HTTP is not suitable for streaming media because it is more of a store-and-forward protocol that is more suitable for web pages and other content that is read repeatedly. Unlike HTTP, RTSP is highly dynamic and provides persistent interactivity between the user device (hereinafter referred to as a client) and server that is beneficial for time-based media. Further, HTTP does not allow for multiple sessions between a client and server, and travels over only a single port. RTP can encapsulate HTTP data, and can be used to dynamically open multiple RTP sessions to deliver many different streams at the same time.

The system 10 employs transmission control software deployed at the encoding facilities 28, which can operate as a network operations center (NOC), and at broadcasters 110 (e.g., master data centers 120) to determine which streams will be available to which nodes in the distribution system 12 and to enable the distribution system 12 to support one-to-one streaming or one-to-many streaming. The extensible language capabilities of RTSP augment the transmission control software at the edge of the distribution network 12. Since RTSP is a bi-directional protocol, its use enables encoders 134 and receivers 144 to talk to each other, allowing for routing, conditional access (e.g., authentication) and bandwidth control in the distribution network 12. Standard RTSP proxies can be provided between any network components to allow them to communicate with each other. The proxy can therefore manage the RTSP traffic without necessarily understanding the actual content.

For every RTSP stream, there is an RTP stream. Further, RTP sessions support data packing with timestamps and sequence numbers. They can also be used for carrying stereo information, wide screen versions of requested media, different audio tracks, and so on. RTP packets are wrapped in a broadcast protocol. Applications in the receiving phase 104 can use this information to determine when to expect the next packet. Further, system operators can use this information to monitor network 12 and satellite 32 connections to determine the extent of latency, if any.

Encoders and data encapsulators written with RTP as the payload standard are advantageous because off-the-shelf encoders (e.g., MPEG2 encoders) can be introduced without changing the system 10. Further, encoders that output RTP/RTSP can connect to RTP/RTSP transmission servers. In addition, the use of specific encoder and receiver combinations can be eliminated when all of the media players support RTP/RTSP.

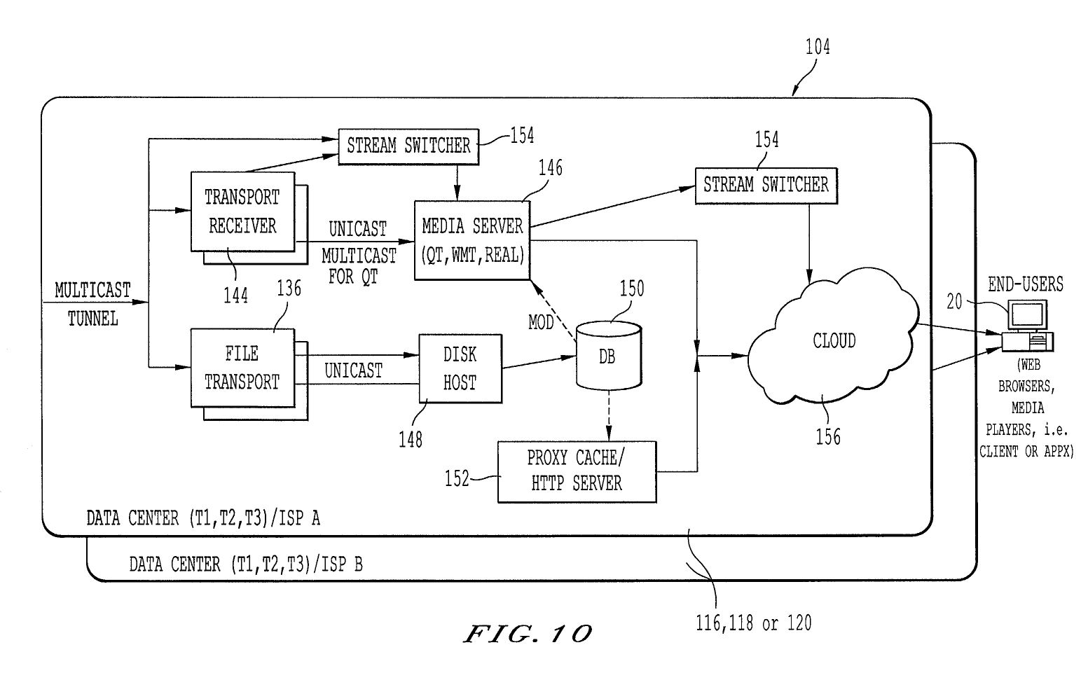

With reference to FIG. 12 and in accordance with an embodiment of the present invention, a proxy is created in software for use between an encoder (e.g., encoder 134) and any device with which the encoder communicates and to which the encoder provides output. The proxy can be implemented, for example, as a stand-alone application or can be compiled into an encoder. The proxy provides for protocol translation to allow the encoder output to be broadcast (e.g., via network 108) and to allow the encoder to appear at a large number of locations to other network devices such as servers (e.g., data centers or servers 14, 16 and 18) or clients 20. In the illustrated embodiment, the proxy is provided in a receiver/protocol converter 180 to allow for a broadcast IP function to be added to an encoder or for a connection to a first generation IP-compatible encoder.

The protocol translation provided by the proxy 180 of the present invention involves determining the types of input that each of a number of different types of encoders 134 is configured to receive. For each type of encoder, the proxy repacketizes packets received from that encoder to initiate a broadcast IP stream. The stream comprises header information that is preferably updated and transmitted periodically within the stream. The header information comprises information such as multiple bit rates used by the encoder, codec information, audio and video channel information, information relating to stereo or surround-sound reception, and the like. The header information also comprises sequence numbers and time stamps. Additional data pertaining to the actual audio and/or video data that the payload represents can also be provided in the packets encoded for broadcasting in accordance with the present invention.

Following broadcast transmission via a network 108, the header facilitates decoding of the stream at a receive site such as a decoder client 22, a destination receiver/protocol converter 182, a server 14, 16 or 18, and so on, as illustrated in FIG. 12. The receive sites (e.g., servers or data centers 14, 16 and 18) are configured to recognize the re-packetized broadcast stream and to parse the broadcast stream to convert it to the real-time stream (e.g., a media-on-demand (MOD) file) generated by the encoder 134. Edge devices in the distribution system 12 can listen to a multicast stream and determine for each packet the stream to which the packet belongs, the metadata associated with that stream, codecs and bit rates used to create the stream, quality of service information, among other types of information. The broadcast packets can therefore be converted to their original packet format for serving to a client 22 in the order with which they were original time-stamped. Further, packets that were unsuccessfully broadcast can be identified. A management device can be added which supports, for example, Simple Network Management Protocol (SNMP) queries about packet loss rate and other information needed to report the quality of bits transmitted via the distribution system 12.

If the proxy is compiled and not a stand-alone application, re-packetizing is not needed. The broadcast stream is instead directly output with header information. Similarly, at the receiver side, there is no re-packetized broadcast stream requiring conversion back to a real-time stream. The receiver applications are instead only concerned with the header information and the payload data.

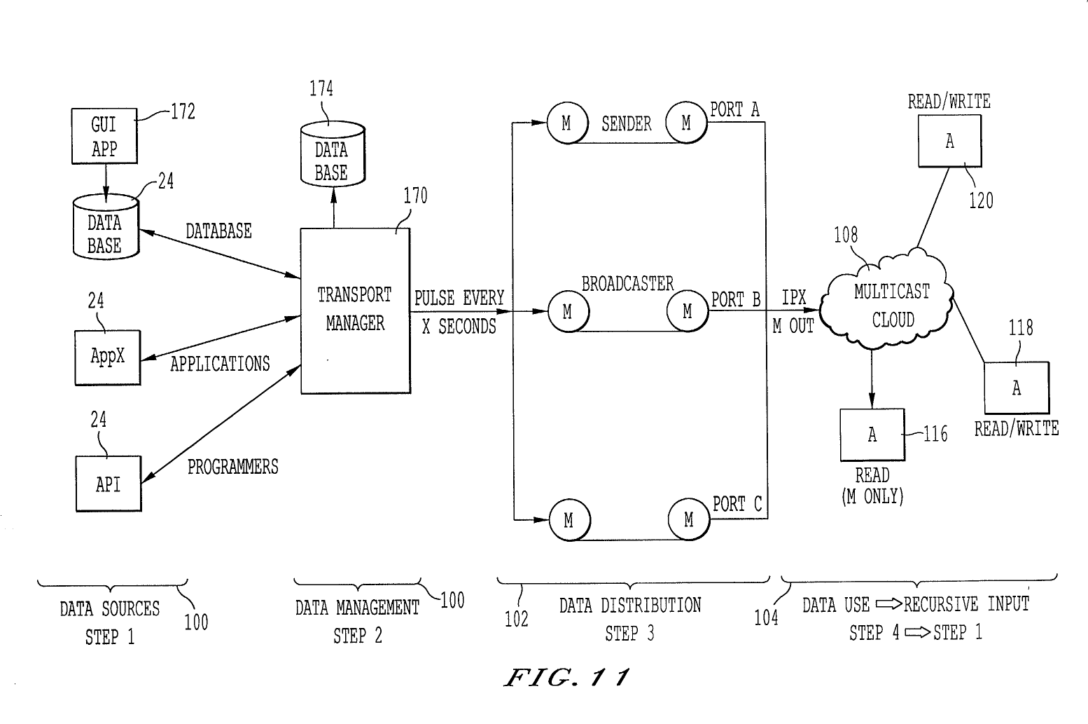

In accordance with another embodiment of the present invention, a server 184 is provided than can simply broadcast an encoded stream over the network 108, as shown in FIG. 13. Remote servers 186 and 188 are provided to receive the same stream. No protocol converters 180 and 182 are needed in this illustrated embodiment. The server 184 is different than existing servers which do not redistribute media streams using multicast. Further, the server 184 is different from an encoder that simply outputs multicast and requires files to be placed on remote sites. The illustrated embodiment in FIG. 13, in contrast, broadcasts the header information, as well as the payload data.

The receiver/protocol converter 182 uses the header information that is multiplexed into the multicast stream or sent on another IP address/port combination to commence a negotiation or hand-shaking process with a receiver (decoder client 20, a destination receiver/protocol converter 182, a server 20, and so on). Information for the negotiation process (e.g., bit rate, method of decoding broadcast payload information in bi-directional communication, reason for connecting, and so on) is therefore provided on a periodic and dynamically updated basis, as opposed to on a payload basis from the origin source. The broadcast stream can be converted, for example, to a bi-directional stream if necessary (i.e., when a receive site such as a client 22 or server 14, 16 or 18 expects to receive such a formatted steam).

The protocol translation of the present invention facilitates the hosting of live/near-live digital video streams on a network. The present invention is operable to essentially any encoder to scale digital video output in a manner similar to analog output of conventional broadcast networks.

Although the present invention has been described with reference to a preferred embodiment thereof, it will be understood that the invention is not limited to the details thereof Various modifications and substitutions will occur to those of ordinary skill in the art. All such substitutions are intended to be embraced within the scope of the invention as defined in the appended claims.

What is claimed is:

1. A method of preparing content for distribution in an Internet broadcast system for streaming media comprising the steps of:
obtaining content intended for distribution via broadcast;
repacketizing said content to generate a broadcast Internet Protocol stream, said stream comprising sequence numbers and time stamps for packets in said content;
storing stream information relating to said stream comprising at least one of identification of input source, destination, groups of devices selected to receive said stream, and stream identification; and
assigning said stream an Internet Protocol address and port in said broadcast system for transmission, said stream information allowing for monitoring recovery of said stream at said destination.

2. A method as claimed in claim 1, wherein said repacketizing step comprises the step of wrapping said packets in said stream using real-time transport protocol.

3. A method as claimed in claim 1, further comprising the step of transmitting said stream using a real-time streaming protocol connection.

4. A method as claimed in claim 1, wherein said obtaining step comprises the step of receiving content from different types of media players, and said repacketizing step comprises the step of wrapping packets from said media players using the same broadcast IP protocol.

5. A method as claimed in claim 1, further comprising the step of transmitting said stream, said stream comprising said content and auxiliary information comprising information relating to codecs and bit rates used to generate said content and data to facilitate reception and identification of said stream when packets therein are received at a reception site.

6. A method as claimed in claim 5, wherein said auxiliary information is updated during said stream.

7. A method as claimed in claim 5, wherein a device for transmitting said stream and a device for receiving said stream communicate via a real-time streaming protocol connection, said transmitting step comprising the step of updating said auxiliary data during said connection.

8. A computer program product for preparing content for distribution in an Internet broadcast system for streaming media comprising:
a computer-readable medium;
an encoding module stored on said computer-readable medium for receiving streams from different media players and wrapping packets in respective streams using a broadcast Internet Protocol common to all of said media players, said encoding module providing auxiliary information in each said stream that relates to that stream;
a reception control module stored on said computer-readable medium and being operable to store information relating to respective said streams to facilitate reception thereof; and
a transmission module stored on said computer-readable medium for commencing and terminating connections to transmit said streams via said Internet broadcast system and operating in conjunction with said reception control module to update said auxiliary information during said stream.

9. A computer program product as claimed in claim 8, wherein said encoding module, said reception control module and said transmission module are compiled in an encoder to allow said encoder to appear at a large number of locations in a network to other network devices.

10. A computer program product as claimed in claim 8, wherein said encoding module, said reception control module and said transmission module are compiled in an encoder to configure said encoder with a proxy for communicating with another device.

11. A computer program product as claimed in claim 8, wherein said computer program product is implemented as a stand-alone application provided at the output of an encoder to configure said encoder with a proxy for communicating with another device.

12. An apparatus for content distribution comprising:
a server; and
an encoding module operable with said server to encode packets to be output via said server into a selected format for transmission as a broadcast Internet Protocol stream.

13. An apparatus as claimed in claim 12, wherein said encoding module is operable to encode said packets corresponding to different streams being served via said server with header information to facilitate which of said packets belong to which of said streams during reception.

14. An apparatus as claimed in claim 13, wherein said header information comprises at least one of bit rates used by said encoding module, audio channel information, video channel information, stereo reception, surround-sound reception, packet sequence numbers, time stamps relating to at least one of said packets and said streams.

15. An apparatus as claimed in claim 13, wherein receivers of said streams employ said header information for converting said broadcast Internet Protocol to another protocol, said header information being dynamically updated.
